(19) United States
(12) Patent Application Publication
(10) Pub. No.: US 2026/0261424 A1
(43) Pub. Date: Sep. 3, 2026

(54) Method to restrict containers and startup sequence in cloud native applications

(71) Applicant: International Business Machines Corporation, Armonk, NY (US)

(72) Inventors: Qi Feng Huo, Haidian District (CN); Da Li Liu, BEIJING (CN); Lei Li, BEIJING (CN); Yan Song Liu, BEIJING (CN); YUAN YUAN WANG, BEIJING (CN)

(21) Appl. No.: 19/066,819

(22) Filed: Feb. 28, 2025

(51) Int. Cl. H04L 9/32

(52) U.S. Cl. CPC H04L 9/3236

(57) ABSTRACT

Regulating execution of containers includes receiving a configuration file associated with a first set of container images. A first initiating sequence of a first set of containers associated with the first set of container images is identified. The first set of container images is retrieved based on the received configuration file. A first ordered set of hash values associated with the retrieved first set of container images is generated. The first ordered set of hash values is compared with a second ordered set of hash values. An execution of the first set of containers is regulated based on the comparison of the first ordered set of hash values with the second ordered set of hash values.

### BACKGROUND

The disclosure relates to containerization and more particularly to container applications.

Container (or containerized) applications are a foundational technology for modern software development, enabling scalability, portability, and efficient management of application workloads. Containers enable developers to package applications with their dependencies, ensuring consistency across different environments. Platforms such as Kubernetes® orchestrate the containers, automating their deployment and scaling across diverse environments. Additionally, Kubernetes® along with additional container orchestration systems, support dynamic and flexible container deployment, allowing for complex application architecture that can scale and adapt to changing workloads.

### SUMMARY

In various embodiments of the disclosure, a computer-implemented method for regulating an execution of containers is described. The computer-implemented method includes receiving, by a computer, a configuration file associated with a first set of container images. The computer-implemented method further includes identifying, by the computer, a first initiating sequence of a first set of containers associated with the first set of container images. The first initiating sequence is identified based on the received configuration file. The computer-implemented method further includes retrieving, by the computer, the first set of container images based on the received configuration file. The computer-implemented method further includes generating, by the computer, a first ordered set of hash values associated with the retrieved first set of container images. The first ordered set of hash values is generated based on the identified first initiating sequence. The computer-implemented method further includes comparing, by the computer, the first ordered set of hash values with a second ordered set of hash values. The second ordered set of hash values is associated with a container policy. The computer-implemented method further includes regulating, by the computer, an execution of the first set of containers based on the comparison of the first ordered set of hash values with the second ordered set of hash values.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for regulating an execution of containers. The program instructions further cause the processor set to receive a deployment contract associated with a first set of container images. The program instructions further cause the processor set to identify a first initiating sequence of a first set of containers associated with the first set of container images. The program instructions further cause the processor set to retrieve the first set of container images based on the received deployment contract. The program instructions further cause the processor set to generate a first ordered set of hash values associated with the retrieved first set of container images. The first ordered set of hash values is generated based on the identified first initiating sequence. The program instructions further cause the processor set to receive a configuration file associated with a second set of container images. The program instructions further cause the processor set to identify a second initiating sequence of a second set of containers associated with the second set of container images. The second initiating sequence is identified based on the received configuration file. The program instructions further cause the processor set to retrieve the second set of container images based on the received configuration file. The program instructions further cause the processor set to generate a second ordered set of hash values associated with the retrieved second set of container images. The second ordered set of hash values is generated based on the identified second initiating sequence. The program instructions further cause the processor set to compare the first ordered set of hash values with the second ordered set of hash values. The program instructions further cause the processor set to regulate the second set of containers based on the comparison of the first ordered set of hash values with the second ordered set of hash values.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for regulating an execution of a set of containers, in accordance with an embodiment of the disclosure;

FIG. 2 is a diagram that illustrates an environment for regulating the execution of the set of containers, in accordance with an embodiment of the disclosure;

FIG. 3 is a diagram that illustrates exemplary operations for generating a policy for the set of containers, in accordance with an embodiment of the disclosure;

FIG. 4 is a diagram that illustrates exemplary operations for regulating the execution of containers, in accordance with an embodiment of the disclosure; and

FIGS. 5A and 5B are diagrams that collectively illustrate a flowchart of an exemplary method for regulating the execution of the set of containers, in accordance with an embodiment of the disclosure.

### DETAILED DESCRIPTION

Container (or containerized) applications are a foundational technology for modern software development, enabling scalability, portability, and efficient management of application workloads. Containers encapsulate application code along with their dependencies, enabling consistent operation across diverse environments. Platforms such as Kubernetes® orchestrate the containers, automating their deployment and scaling across diverse environments. Additionally, Kubernetes® along with additional container orchestration systems, support dynamic and flexible container deployment, allowing for complex application architecture that can scale and adapt to changing workloads. As applications grow in complexity, ensuring that the containers are deployed in the correct order with verified configurations is recommended for maintaining security and performance. Deviations from defined execution sequences, use of unverified configurations, or omissions of containers may result in security vulnerabilities, data exposure, or operational failures.

Conventional systems implement security measures by incorporating deployment constraints into a Yet Another Markup Language (YAML) file or additional configuration files. These files specify containers, define their initialization sequence, and include parameters for deployment. Additionally, the conventional system employs policies to restrict the use of unauthorized container images and ensure compliance with configurations for the deployment of the containers. Confidential containers further enhance security by utilizing policies and contracts to define allowed open container initiative (OCI) images, ensuring that only authorized images can be executed within a pod while preventing the execution of the containers associated with the unauthorized container images. However, vulnerabilities persist, such as the possibility of tampering with YAML files to skip specific containers or alter the startup order of the containers, which can compromise the integrity of the deployment.

To address these issues, a system that regulates the execution of containers is disclosed. Such a system receives a configuration file associated with a first set of container images. Further, the system identifies a first initiating sequence of a first set of containers associated with the first set of container images. The first initiating sequence is identified based on the received configuration file. The system further retrieves the first set of container images based on the received configuration file. The system further generates a first ordered set of hash values associated with the retrieved first set of container images. Further, the system compares the first ordered set of hash values with a second ordered set of hash values. The second ordered set of hash values is associated with a container policy. Based on the comparison of the first ordered set of hash values with the second ordered set of hash values, the system regulates the execution of the first set of containers.

The disclosed system provides a robust and secure mechanism to enhance the security and the reliability of execution of the set of containers by integrating policy-driven controls and hash-based validation. By generating the first ordered set of hash values, the system verifies the execution of the set of containers to prevent the skipping of any particular containers within a pod. By leveraging the container policy that specifies a recommended sequence of the set of containers generated from the set of container images, the system ensures strict adherence to the defined initiation sequence (e.g., a first initiating sequence) in the container policy. Thus, the system mitigates risks associated with possible tampering of the configuration file such as altering the first initiating sequence or skipping one or more containers that are critical, thereby preserving operational integrity associated with the set of containers.

In various embodiments of the disclosure, a computer-implemented method for regulating an execution of containers is described. The computer-implemented method includes receiving, by a computer, a configuration file associated with a first set of container images. The computer-implemented method further includes identifying, by the computer, a first initiating sequence of a first set of containers associated with the first set of container images. The first initiating sequence is identified based on the received configuration file. The computer-implemented method further includes retrieving, by the computer, the first set of container images based on the received configuration file. The computer-implemented method further includes generating, by the computer, a first ordered set of hash values associated with the retrieved first set of container images. The first ordered set of hash values is generated based on the identified first initiating sequence. The computer-implemented method further includes comparing, by the computer, the first ordered set of hash values with a second ordered set of hash values. The second ordered set of hash values is associated with a container policy. The computer-implemented method further includes regulating, by the computer, an execution of the first set of containers based on the comparison of the first ordered set of hash values with the second ordered set of hash values.

In various embodiments of the disclosure, the computer-implemented method further includes receiving, by the computer, a deployment contract associated with a second set of container images. The computer-implemented method further includes identifying, by the computer, a second initiating sequence of a second set of containers associated with the second set of container images. The second initiating sequence is identified based on the received deployment contract. The computer-implemented method further includes retrieving, by the computer, the second set of container images based on the received deployment contract. The computer-implemented method further includes generating, by the computer, the second ordered set of hash values associated with the retrieved second set of container images. The second ordered set of hash values is generated based on the identified second initiating sequence. The computer-implemented method further includes generating, by the computer, the container policy based on the second ordered set of hash values.

In various embodiments of the disclosure, the computer-implemented method further includes comparing, by the computer, a hash value of the first ordered set of hash values with a hash value of the second ordered set of hash values.

In various embodiments of the disclosure, the hash value of the first ordered set of hash values is associated with a container image of the retrieved first set of container images. The computer-implemented method further includes regulating, by the computer, the execution of a container of the first set of containers based on the comparison of the hash value of the first ordered set of hash values with the hash value of the second ordered set of hash values. The container is associated with the container image.

In various embodiments of the disclosure, the hash value of the first ordered set of hash values includes a first root filesystem hash value associated with the container image and a first argument hash value associated with the container image.

In various embodiments of the disclosure, the computer-implemented method further includes determining, by the computer, a mismatch between the hash value of the first ordered set of hash values and the hash value of the second ordered set of hash values based on the comparison of the hash value of the first ordered set of hash values with the hash value of the second ordered set of hash values. The computer-implemented method further includes regulating, by the computer, the execution of the container based on the determination of the mismatch. The regulation of the execution of the container corresponds to restriction of the execution of the container.

In various embodiments of the disclosure, the computer-implemented method further includes terminating, by the computer, a pod deployment operation associated with the retrieved first set of container images based on the determination of the mismatch and the regulation of the execution of the container.

In various embodiments of the disclosure, the computer-implemented method further includes determining, by the computer, a match between the hash value of the first ordered set of hash values and the hash value of the second ordered set of hash values based on the comparison of the hash value of the first ordered set of hash values with the hash value of the second ordered set of hash values. The computer-implemented method further includes regulating, by the computer, the execution of the container based on the determination of the match. The regulation of the execution of the container corresponds to initiation of the execution of the container.

In various embodiments of the disclosure, the computer-implemented method further includes modifying, by the computer, a counter value indicating a regulation count associated with the first set of containers based on the comparison of the first ordered set of hash values with the second ordered set of hash values. The computer-implemented method further includes comparing, by the computer, a positional value associated with a hash value of the first ordered set of hash values with the counter value. The computer-implemented method further includes regulating, by the computer, the execution of a container of the first set of containers based on the comparison of the positional value with the counter value. The container is associated with a container image of the retrieved first set of container images.

In various embodiments of the disclosure, the computer-implemented method further includes determining, by the computer, a mismatch between the positional value and the counter value based on the comparison of the positional value and the counter value. The computer-implemented method further includes regulating, by the computer, the execution of the container based on the determination of the mismatch. The regulation of the execution of the container corresponds to restriction of the execution of the container.

In various embodiments of the disclosure, the computer-implemented method further includes determining, by the computer, a match between the positional value and the counter value based on the comparison of the positional value and the counter value. The computer-implemented method further includes regulating, by the computer, the execution of the container based on the determination of the match. The regulation of the execution of the container corresponds to initiation of the execution of the container.

In various embodiments of the disclosure, the computer-implemented method further includes applying, by the computer, a hash function on the retrieved first set of container images. The computer-implemented method further includes generating, by the computer, the first ordered set of hash values associated with the retrieved first set of container images. The first ordered set of hash values is generated based on the identified first initiating sequence and the application of the hash function on the retrieved first set of container images.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for regulating an execution of containers. The program instructions further cause the processor set to receive a deployment contract associated with a first set of container images. The program instructions further cause the processor set to identify a first initiating sequence of a first set of containers associated with the first set of container images. The program instructions further cause the processor set to retrieve the first set of container images based on the received deployment contract. The program instructions further cause the processor set to generate a first ordered set of hash values associated with the retrieved first set of container images. The first ordered set of hash values is generated based on the identified first initiating sequence. The program instructions further cause the processor set to receive a configuration file associated with a second set of container images. The program instructions further cause the processor set to identify a second initiating sequence of a second set of containers associated with the second set of container images. The second initiating sequence is identified based on the received configuration file. The program instructions further cause the processor set to retrieve the second set of container images based on the received configuration file. The program instructions further cause the processor set to generate a second ordered set of hash values associated with the retrieved second set of container images. The second ordered set of hash values is generated based on the identified second initiating sequence. The program instructions further cause the processor set to compare the first ordered set of hash values with the second ordered set of hash values. The program instructions further cause the processor set to regulate the second set of containers based on the comparison of the first ordered set of hash values with the second ordered set of hash values.

In various embodiments of the disclosure, the program instructions further cause the processor set to compare a hash value of the first ordered set of hash values with a hash value of the second ordered set of hash values.

In various embodiments of the disclosure, the hash value of the first ordered set of hash values is associated with a container image of the retrieved first set of container images. The hash value of the second ordered set of hash values is associated with a container image of the retrieved second set of container images. The program instructions further cause the processor set to regulate an execution of a container of the set of containers based on the comparison of the hash value of the first ordered set of hash values with the hash value of the second ordered set of hash values. The container is associated with the container image of the retrieved second set of container images.

In various embodiments of the disclosure, the hash value of the first ordered set of hash values includes, a first root filesystem hash value associated with the container image of the retrieved first set of container images, and a first argument hash value associated with the container image of the retrieved first set of container images. The hash value of the second ordered set of hash values includes, a second root filesystem hash value associated with the container image of the retrieved second set of container images, and a second argument hash value associated with the container image of the retrieved second set of container images.

In various embodiments of the disclosure, the program instructions further cause the processor set to determine a mismatch between the hash value of the first ordered set of hash values and the hash value of the second ordered set of hash values based on the comparison of the hash value of the first ordered set of hash values with the hash value of the second ordered set of hash values. The program instructions further cause the processor set to regulate the execution of the container based on the determination of the mismatch. The regulation of the execution of the container corresponds to a restriction on the execution of the container.

In various embodiments of the disclosure, the program instructions further cause the processor set to terminate a pod deployment operation associated with the retrieved second set of container images based on the determination of the mismatch and the regulation of the execution of the container.

In various embodiments of the disclosure, the program instructions further cause the processor set to determine a match between the hash value of the first ordered set of hash values and the hash value of the second ordered set of hash values based on the comparison of the hash value of the first ordered set of hash values with the hash value of the first ordered set of hash values. The program instructions further cause the processor set to regulate the execution of the container based on the determination of the match. The regulation of the execution of the container corresponds to an initiation of the execution of the container.

In various embodiments of the disclosure, a computer-program product is described. The computer-program product includes one or more computer-readable storage media and program instructions stored on the one or more computer-readable storage media to perform operations for regulating execution of containers. The operations include receiving a configuration file associated with a first set of container images. The operations further include identifying a first initiating sequence of a first set of containers associated with the first set of container images. The first initiating sequence is identified based on the received configuration file. The operations further include retrieving the first set of container images based on the received configuration file. The operations further include generating a first ordered set of hash values associated with the retrieved first set of container images. The first ordered set of hash values is generated based on the identified first initiating sequence. The operations further include comparing the first ordered set of hash values with a second ordered set of hash values associated with a container policy. The operations further include regulating an execution of the first set of containers based on the comparison of the first ordered set of hash values with the second ordered set of hash values.

Additional technical features and benefits are realized through the techniques of the disclosure. Embodiments and aspects of the disclosure are described in detail herein and are considered a part of the claimed subject matter. For a better understanding, refer to the detailed description and to the drawings.

Various aspects of the disclosure are described by narrative text, flowcharts, block diagrams of computer systems and/or block diagrams of the machine logic included in computer-program product (CPP) embodiments. With respect to any flowcharts, depending upon the technology involved, the operations can be performed in a different order than what is shown in a given flowchart. For example, again depending upon the technology involved, two operations shown in successive flowchart blocks could be performed in reverse order, as a single integrated operation, concurrently, or in a manner at least partially overlapping in time.

A computer-program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium could be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or additional freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

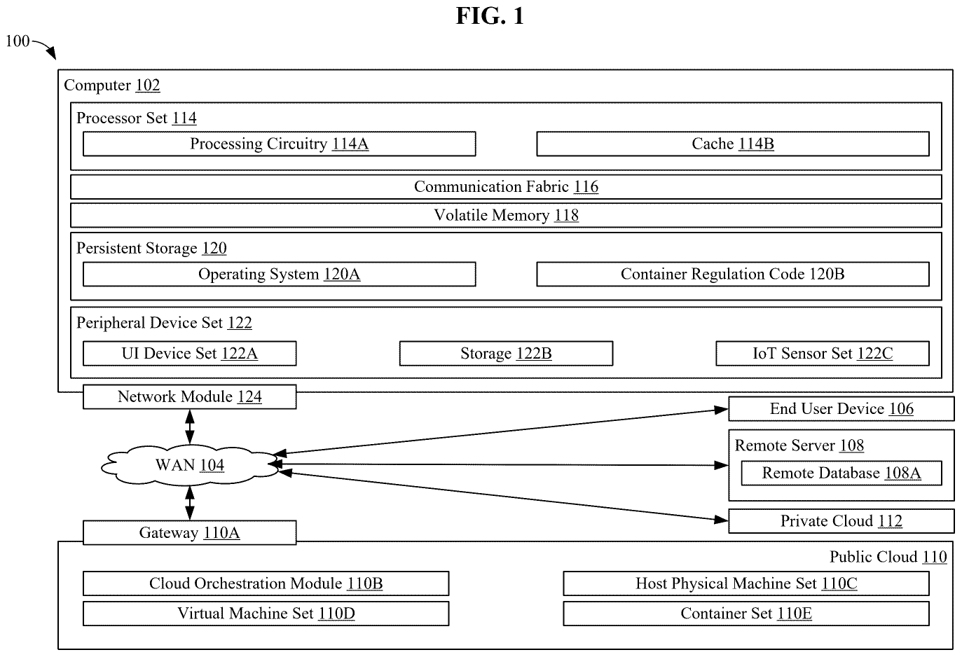

FIG. 1 is a diagram that illustrates a computing environment for regulating an execution of containers, in accordance with an embodiment of the disclosure. With reference to FIG. 1, there is shown a computing environment 100 that contains an example of an environment for the execution of at least some of the computer code involved in performing the disclosed methods, such as container regulation code 120B. In addition to the container regulation code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the container regulation code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or additional wearable computer, a mainframe computer, a quantum computer, or any form of a computer or a mobile device now known or to be developed in the future that is configured for running a program, accessing a network or querying a database, such as the remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though it is not shown in a cloud in FIG. 1. In an alternate embodiment, computer 102 is not in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the additional storage media discussed below. The program instructions, and associated data, are accessed by the processor set 114 to control and direct the performance of the disclosed methods. In computing environment 100, at least some of the instructions for performing the disclosed methods may be stored in the dynamic modification of the container regulation code 120B in persistent storage 120.

The communication fabric 116 is the signal conduction path that allows the various components of computer 102 to intercommunicate. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is applicable when explicitly indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the container regulation code 120B typically includes at least some of the computer code involved in performing the disclosed methods.

The peripheral device set 122 includes the set of peripheral devices of the computer 102. Data communication connections between the peripheral devices and the additional components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where the computer 102 is recommended to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows the computer 102 to communicate with one or more computers through the WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is any wide area network (for example, the internet) configured for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or alternatively present recommendations to an end user. In some embodiments of the disclosure, the EUD 106 may be a client device, such as a mainframe computer, a desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by the one or more computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or additional computer functionality, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through the WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer-program running on an ordinary operating system can utilize most resources of that computer, such as connected devices, files and folders, network shares, CPU power, and quantifiable hardware functionalities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, the private cloud 112 may be disconnected from the internet entirely and only accessible through a local/private network. A hybrid cloud is a composition of multiple clouds of different types (for example, private, community, or public cloud types), often respectively implemented by different vendors. Each cloud of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

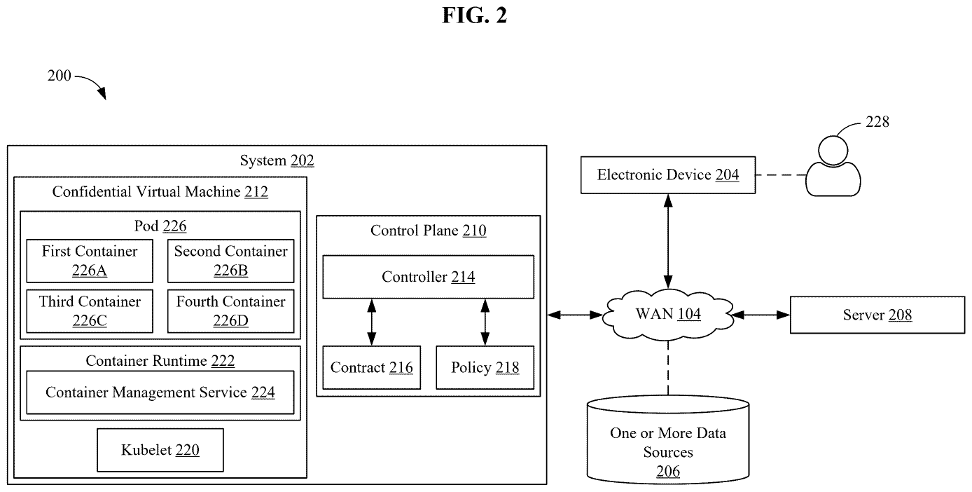

FIG. 2 is a diagram that illustrates an environment for regulating the execution of the set of containers, in accordance with an embodiment of the disclosure. FIG. 2 is explained in conjunction with elements from FIG. 1. With reference to FIG. 2, there is shown a diagram of a network environment 200. The network environment 200 includes a system 202 (also called computer system), an electronic device 204, one or more data sources 206, and a server 208. Further, the network environment 200 includes the WAN 104 of FIG. 1. In an embodiment of the disclosure, the system 202 may be an exemplary embodiment of the computer 102 of FIG. 1.

The system 202 may include suitable logic, circuitry, interfaces, and/or code that may be configured for regulating the execution of containers. The system 202 may be configured to receive a deployment contract associated with a first set of container images. In an embodiment, the deployment contract may define a set of rules, constraints, and parameters under which a pod that includes containers (associated with the first set of container images) is to be deployed. A container may correspond to a lightweight, portable unit of software that encapsulates an application and its dependencies, allowing it to run consistently across different environments such as a development environment, a testing environment, a staging environment, and the like. Further, the pod may correspond to a smallest deployable unit in Kubernetes® that encapsulates one or more containers that share the same network namespace, storage, and configuration options. The Pod (or pods) may enable tightly coupled containers to run together in an isolated environment, providing communication and resource sharing among the containers. For example, the pod may include a web server container running nginx to handle hypertext transfer protocol (HTTP) requests from clients. Additionally, the pod may include a database container running MySQL, that stores and retrieves data from a web application. Since both the web server and database are housed within the same pod, they share the same network namespace, allowing them to communicate directly using “localhost”. This setup enables fast data retrieval and storage without the latency that may typically be associated with inter-pod communication.

In an embodiment, the deployment contract may include specification of authorized container images, a first initiating sequence of a first set of containers associated with the first set of container images, security requirements associated with the first set of containers, integrity check associated with the first set of containers, and additional operational characteristics that must be adhered to during deployment of the pod. For example, the deployment contract may specify that only certain approved versions of a container image, such as myapp:v1.0 (first version) or myapp:v2.0 (first version), are allowed for deployment within the pod.

The system 202 may be further configured to identify the first initiating sequence of the first set of containers. The system 202 may be further configured to retrieve the first set of container images based on the received deployment contract. Further, the system 202 may be configured to generate a first ordered set of hash values associated with the first set of container images. The first ordered set of hash values may be generated based on the identified first initiating sequence. The system 202 may be further configured to generate a container policy based on the first ordered set of hash values. In an embodiment, the system 202 may generate a container policy that may include the first ordered set of hash values.

The system 202 may be further configured to receive a configuration file associated with a second set of container images. The system 202 may be further configured to identify a second initiating sequence of a second set of containers associated with the second set of container images. The system 202 may be further configured to retrieve the second set of container images based on the received configuration file. Further, the system 202 may be configured to generate a second ordered set of hash values associated with the retrieved second set of container images. The second ordered set of hash values may be generated based on the identified second initiating sequence. Additionally, the system 202 may be further configured to compare the first ordered set of hash values with the second ordered set of hash values. Based on the comparison, the system 202 may be further configured to regulate an execution of the second set of containers. Thus, by comparing the first ordered set of hash values from the container policy with the second ordered set of hash values, the system 202 ensures that the second set of containers is executed in a defined sequence, preventing unauthorized modifications such as sequence tampering or container omission.

The electronic device 204 may include suitable logic, circuitry, interfaces, and/or code that may be configured to receive first input data from the user 228. In an embodiment, the first input data may include references associated with the first set of container images (e.g., image names, repository uniform resource locator, tags, and the like). For example, the user 228 may specify container images such as nginx:v1.2 and database:v3.1 along with their respective configurations (e.g., resource limits, environment variables, or ports to expose). The first input data may further include a desired startup order (e.g., the first initiating sequence) associated with the first set of containers. For example, the first input data may define that the database container may start before the web server container. Based on the first input data, the electronic device 204 may be configured to generate the deployment contract. The electronic device 204 may be further configured to provide the deployment contract to the system 202. Examples of the electronic device 204 may correspond to a computing device such as a personal computer, a workstation, or the like.

In an embodiment, the electronic device 204 may be further configured to receive second input data from the user 228. The second input data may be associated with the first set of container images and may assist in the generation of the configuration file that may be tailored for the specific operational requirements of the user 228. Based on the first input data and the second input data, the electronic device 204 may be configured to generate the configuration file. In an embodiment, the configuration file may include user-defined preferences (e.g., localization options, user-defined threshold for specific operations, and the like) associated with the first set of container images, system parameters (e.g., memory allocation, CPU usage limits, network configuration, and the like) associated with the first set of container images, or additional configuration (e.g., setting up persistent storage, configuring environment variables and secrets for sensitive data) associated with the first set of container images.

The configuration file may be structured as a Yet Another Markup Language (YAML) file, Hypertext Markup Language (HTML) file, Extensible Hypertext Markup Language (XHTML) file, and XML Metadata Interchange (XML) file, and the like. The electronic device 204 may be configured to provide the configuration file to the system 202 such that the configuration file may be associated with the first set of container images. In an embodiment, the configuration file may be susceptible to unauthorized modification or tampering that may result in deviations from defined execution sequences of the containers, use of unverified configurations for the containers, or omissions of containers that may result in security vulnerabilities, data exposure, or operational failures. For example, if an istio container is skipped, the data transit over the Kubernetes overlay network may not be protected by service mesh certificate, authentication, and authorization. In an additional example, the deployment contract may be associated with the first set of container images such as a container image A, a container image B, a container image C, and a container image D. Further, the configuration file may also be associated with the first set of container images. During the transmission of the configuration file, a malicious actor (e.g., a hacker, an attacker, and the like) may modify the configuration file such that the configuration file may now be associated with the second set of container images such as a container image X, the container image B, the container image C, and the container image D. Thus, compromising integrity of container deployment associated with the first set of container images. For the sake of the upcoming explanation, it is therefore assumed that the configuration file is associated with the second set of container images. The second set of container images may or may not be the same as the first set of container images.

The one or more data sources 206 may correspond to an organized collection of container images that may be stored and accessed electronically from a computer system (such as the system 202). In an embodiment, the one or more data sources 206 may be an image repository. Thus, the one or more data sources 206 may correspond to a centralized storage system where the container images (e.g., the first set of container images) are stored, managed, and distributed. The one or more data sources 206 may allow developers (such as the user 228) to upload, store, and pull the container images. In an embodiment, the one or more data sources 206 may correspond to a public image repository or a private image repository. The public image repository may include platforms such as Docker Hub®, Harbor®, and the like, which host publicly available images. For example, a default nginx image (nginx: alpine) may be retrieved for lightweight web servers. The private image repository may include an organization-specific registry that may store proprietary images. For example, an internal repository may store sensitive container images used in confidential applications and may be accessible through authenticated devices.

The server 208 may include suitable logic, circuitry, interfaces, and/or code that may be configured to host the system 202. Upon receiving the first input data, the server 208 may be further configured to store the first input data. The server 208 may be implemented as a cloud server and may execute operations through web applications, cloud applications, HTTP requests, repository operations, file transfer, and the like. Additional example implementations of the server 208 may include, but are not limited to, a database server, a file server, a web server, a media server, an application server, a mainframe server, or a cloud computing server.

In an embodiment of the disclosure, the server 208 may be implemented as a plurality of distributed cloud-based resources by use of several technologies that are well known to those ordinarily skilled in the art. A person with ordinary skill in the art will understand that the scope of the disclosure may not be limited to the implementation of the server 208 and the system 202 as two separate entities. In certain embodiments, the functionalities of the server 208 can be incorporated in its entirety or at least partially in the system 202, without a departure from the scope of the disclosure.

In an embodiment, the system 202 may be a software framework that enables the deployment, management, and scaling of containerized applications. The system 202 provides a consistent runtime environment by encapsulating the containerized application and its dependencies within the containers, ensuring seamless operation across various computing environments. Further, the system 202 may offer tools and services for orchestrating containers, optimizing resource utilization, and automating tasks such as scaling and fault tolerance. Examples of different types of the system 202 include container engines (such as docker), container orchestrators (such as the Kubernetes® and OpenShift®), and the like.

The system 202 may include a control plane 210, and a confidential virtual machine 212. The control plane 210 may include suitable logic, circuitry, interfaces, and/or code that may be configured to perform a range of functions within the system 202. The range of functions may include orchestrating deployment and operations of the containers within the system 202. In an embodiment, the control plane 210 may act as a primary interface between an external entity to the system 202 such as the electronic device 204, and an internal entity of the system 202 such as the confidential virtual machine 212. The control plane 210 may be further configured to make high-level decisions regarding resource allocation, scheduling container deployment, and maintaining the overall health of the system 202.

For the sake of brevity, the system 202 is shown to include the confidential virtual machine 212 in FIG. 2, in actual implementation the system 202 may include a plurality of confidential virtual machines that may or may not be identical to the confidential virtual machine 212. In an embodiment, the control plane 210 may be configured to receive the deployment contract from the electronic device 204. The deployment contract may be associated with the first set of container images. Further, the control plane 210 may be configured to receive the configuration file from the electronic device 204. The configuration file may be associated with the second set of container images. Based on the configuration file, the control plane 210 may be further configured to generate deployment instructions.

The deployment instructions may include details associated with the second set of container images as included in the configuration file such as the user-defined preferences (e.g., localization options, user-defined threshold for specific operations, and the like), system parameters (e.g., memory allocation, CPU usage limits, network configuration, and the like), or additional configuration (e.g., setting up persistent storage, configuring environment variables and secrets for sensitive data). The control plane 210 may be further configured to provide the deployment instructions to the confidential virtual machine 212.

The confidential virtual machine 212 may correspond to secure and isolated environments for the containers within a pod, ensuring that they share the same security context and resources while being protected from various pods on the same host (e.g., the confidential virtual machine 212), thereby maintaining confidentiality, integrity, and authenticity of data and processes. In an embodiment, the confidential virtual machine 212 may be configured to receive the deployment instructions from the control plane 210 for deployment of the pod.

In an embodiment, the control plane 210 may include a controller 214. The controller 214 may correspond to an agent installed on the control plane 210. The controller 214 may be configured to interact with the electronic device 204 and the confidential virtual machine 212 to manage the execution of the containers on the confidential virtual machine 212. The controller 214 may be configured to receive the deployment contract from the electronic device 204. The deployment contract may be associated with the first set of container images. The controller 214 may be further configured to store the deployment contract. The deployment contract is hereinafter referred to as a “contract 216”. The controller 214 may be further configured to identify the first initiating sequence of the first set of containers associated with the first set of container images.

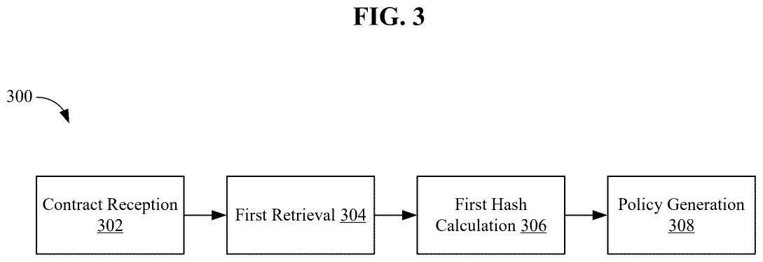

The controller 214 may be further configured to retrieve the first set of container images based on the contract 216. Additionally, the controller 214 may be further configured to generate the first ordered set of hash values associated with the retrieved first set of container images. The first ordered set of hash values may be generated based on the identified first initiating sequence such that the first ordered set of hash values may be arranged based on the first initiating sequence. The controller 214 may be further configured to generate the container policy including the first ordered set of hash values. The controller 214 may be further configured to store the container policy. The container policy is hereinafter referred to as a “policy 218”. Details about the generation of the policy 218 are provided, for example, in FIG. 3. In an embodiment, the controller 214 may be configured to receive the configuration file from the electronic device 204. Based on the received configuration file, the controller 214 may be further configured to generate the deployment instructions. The controller 214 may be further configured to provide the deployment instructions to the confidential virtual machine 212.

In an embodiment, the confidential virtual machine 212 may include a kubelet 220, and a container runtime 222. The kubelet 220 may correspond to an agent installed on the confidential virtual machine 212. The kubelet 220 may be configured to interact with the controller 214 to manage the execution of the containers on the confidential virtual machine 212. The kubelet 220 may be further configured to receive the deployment instructions from the controller 214. Based on the received deployment instructions, the kubelet 220 may be further configured to manage the lifecycle of pods such as scheduling the containers for execution, updating container images, reporting container health status, and handling container failures or restarts. In an embodiment, the kubelet 220 may be further configured to generate a container runtime interface (CRI) request to communicate with the container runtime 222. Based on the CRI request, the kubelet 220 may provide the deployment instructions received from the control plane 210 to the container runtime 222. In an embodiment, the kubelet 220 may communicate with the container runtime 222 through a plugin interface (e.g., a container runtime interface) that allows the kubelet 220 to interact with the container runtime 222 without requiring recompilation of various components.

The container runtime 222 may correspond to a software component that may be installed on the confidential virtual machine 212 to execute and manage operations such as the execution of the containers. Examples of the container runtime may include docker, containerd, or container runtime interface-open (CRI-O). In an embodiment, the container runtime 222 may include a container management service 224. The container management service 224 may be configured to manage and orchestrate container lifecycle operations within the confidential virtual machine 212. The container management service 224 may handle low-level operations that may be recommended for container initialization, execution, and monitoring.

The container management service 224 may be configured to receive the CRI request (including the deployment instructions) from the kubelet 220. Based on the CRI request, the container management service 224 may be further configured to identify the second initiating sequence of the second set of containers associated with the second set of container images. Further, the container management service 224 may be configured to retrieve the second set of container images based on the CRI request. The container management service 224 may retrieve (or pull) the second set of container images from the one or more data sources 206. Additionally, the container management service 224 may be further configured to generate the second ordered set of hash values associated with the retrieved second set of container images. The second ordered set of hash values may be generated based on the identified second initiating sequence such that the second ordered set of hash values may be arranged based on the second initiating sequence.

The container management service 224 may be further configured to compare the first ordered set of hash values with the second ordered set of hash values. Based on the comparison, the container management service 224 may be further configured to regulate the execution of the set of containers associated with the retrieved second set of container images.

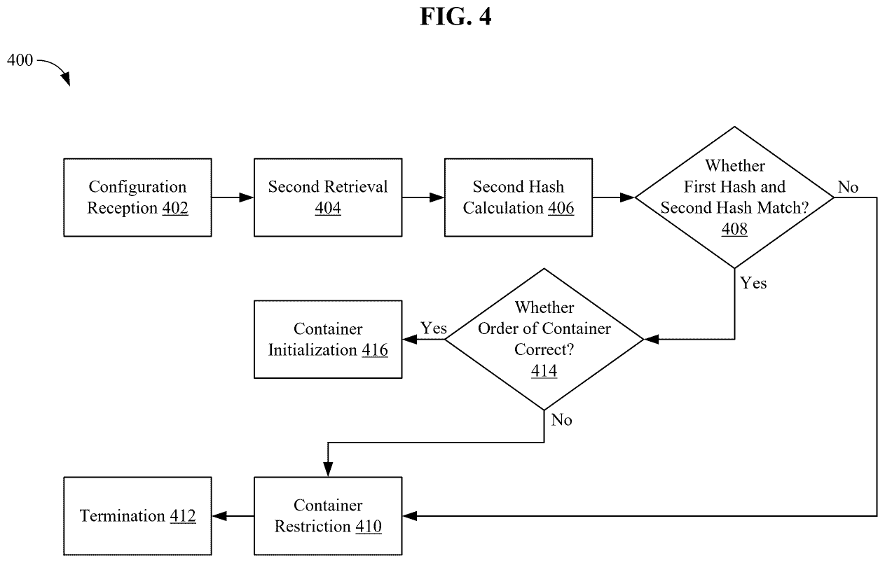

In an embodiment, the retrieved second set of container images may be associated with containers defined for a pod 226. The pod 226 may correspond to a logical grouping of the containers (e.g., the second set of containers) that may share same lifecycle and may communicate among themselves as defined in the CRI request. The second set of containers may be instantiated from the retrieved second set of container images. The pod 226 is shown to include the second set of containers such as a first container 226A, a second container 226B, a third container 226C, and a fourth container 226D. Each container of the second set of containers may be instantiated from a respective container image of the retrieved second set of container images. Details about the regulation of the execution of the second set of containers are provided, for example, in FIG. 4.

In operation, the controller 214 may be configured to receive the deployment contract associated with the first set of container images. The first set of container images may be in the first initiating sequence. In an embodiment, the deployment contract may correspond to specification that may define a set of rules, constraints, and parameters under which a pod that includes containers (associated with the first set of container images) is to be deployed. The controller 214 may be further configured to retrieve the first set of container images based on the deployment contract. Further, the controller 214 may be configured to generate the first ordered set of hash values associated with the retrieved first set of container images. The controller 214 may be further configured to generate the policy 218 including the first ordered set of hash values. The first ordered set of hash values may be arranged based on the first initiating sequence. The controller 214 may be further configured to receive the configuration file associated with the second set of container images. In an embodiment, the second set of container images may be in the second initiating sequence. Further, the controller 214 may be further configured to generate the deployment instructions to perform the range of functions on the kubelet 220.

The kubelet 220 may be further configured to receive the deployment instructions from the controller 214. Based on the received instructions, the kubelet 220 may be further configured to perform various functions such as schedule containers for execution, update container images, report container health status, and handle container failure or restarts, thereby managing container lifecycle operations such as which container to deploy, resource allocation parameters (e.g., CPU limits, or memory limits), scaling requirements, or additional tasks that may be recommended to maintain a desired state of the confidential virtual machine 212. In an embodiment, the kubelet 220 may be further configured to generate the CRI request to communicate with the container management service 224 of the container runtime 222.

The container management service 224 may be configured to receive the CRI request from the kubelet 220. Based on the CRI request, the container management service 224 may be further configured to identify the second initiating sequence of the second set of containers associated with the second set of container images. Further, the container management service 224 may be configured to retrieve the second set of container images. Additionally, the container management service 224 may be further configured to generate the second ordered set of hash values associated with the retrieved second set of container images. The container management service 224 may be further configured to compare the first ordered set of hash values with the second ordered set of hash values. Based on the comparison, the container management service 224 may be further configured to regulate the execution of the second set of containers associated.

FIG. 3 is a diagram that illustrates exemplary operations for generating a policy for the set of containers, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 308, as described herein. The exemplary operations illustrated in the block diagram 300 may start at 302 and may be performed by any computing system, apparatus, or device, such as by the computer 102 of FIG. 1 or the system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, a contract reception operation may be executed. In an embodiment, in the contract reception operation, the controller 214 may be configured to receive the contract 216 associated with the first set of container images. The contract 216 may define the set of rules, the constraints, and the parameters under which a pod that includes containers (associated with the first set of container images) is to be deployed. Further, the contract 216 may include specification of authorized container images, the first initiating sequence, the security requirements, the integrity check, and the additional operational characteristics that must be adhered to during the deployment. For example, the contract 216 may specify that only certain approved versions of a container image, such as myapp:v1.0 or myapp:v2.0, are allowed for deployment within a pod. The controller 214 may be further configured to store the contract 216. The controller 214 may be further configured to identify the first initiating sequence of the first set of containers associated with the first set of container images based on the contract 216.

The controller 214 may be further configured to extract image identifiers associated with the first set of container images from the contract 216. Examples of the image identifiers may include image names, tags, or cryptographic hashes. In an embodiment, the image identifiers may serve as references to locate (and retrieve) the first set of container images from the one or more data sources 206 (e.g., the image repository). The one or more data sources 206 may correspond to a centralized storage system where container images (e.g., the first set of container images) may be stored, managed, and distributed. The one or more data sources 206 may allow developers (such as the user 228) to upload, store, and pull the container images. The one or more data sources 206 may correspond to a public image repository or a private image repository. The public image repository may include platforms such as Docker Hub®, Harbor®, and the like, which host publicly available images.

At 304, a first retrieval operation may be executed. In an embodiment, in the first retrieval operation, the controller 214 may be further configured to identify the first initiating sequence of the first set of containers associated with the first set of container images. The controller 214 may be further configured to establish a secure communication channel with the one or more data sources 206 (e.g., the image repository) to ensure data integrity and confidentiality during the first retrieval operation. The secure communication channel may utilize encryption protocols such as transport layer security (TLS) to safeguard the transmission of data, thereby ensuring the first set of container images are not intercepted or tampered with during transit.

Prior to initiating the retrieval of the first set of container images, the controller 214 may be further configured to perform an authentication handshake with the one or more data sources 206. This handshake may include validating credentials such as usernames and passwords, or more robust authentication mechanisms such as cryptographic tokens, digital certificates, and the like. For example, if the one or more data sources 206 may require token-based authentication, the controller 214 may provide a valid token to gain access to the one or more data sources 206. Once authenticated, the controller 214 may be further configured to query the one or more data sources 206 (e.g., the image repository) based on the contract 216 to locate the first set of container images. Further, the controller 214 may be configured to retrieve (or pull) the first set of container images from the one or more data sources 206 based on the contract 216.

At 306, a first hash calculation operation may be executed. In an embodiment, in the first hash calculation operation, the controller 214 may be configured to apply a hash function on the retrieved first set of container images. The hash function may correspond to a mathematical algorithm that may convert an input into a fixed-size output that may be referred to as a hash value. The hash value is a unique representation of the input such that minor changes in the input may generate a different output hash value (e.g., an alternate hash value). Examples of the hash function may include cryptographic algorithms such as secure hashing algorithm (SHA)-256, SHA-384, and the like. The SHA-256 may generate a fixed-size output of 256 bits (32 bytes), that may be represented as a 64-character hexadecimal string. Similarly, the SHA-384 may generate a fixed-size output of 384 bits (48 bytes), that may be represented as a 96-character hexadecimal string.

The hash function may be characterized by its deterministic nature, such that the same input will produce the same hash value. Additionally, the hash function may offer strong collision resistance, making it computationally infeasible to find two distinct inputs that yield the same hash value. Further, the hash function may demonstrate an avalanche effect, such that a minor alteration in the input may result in a significantly different hash value, thereby reinforcing one-way function property of the hash function that makes it nearly impossible to derive the original input from its hash value.

The controller 214 may be further configured to generate the first ordered set of hash values associated with the retrieved first set of container images. The first ordered set of hash values may be computed based on the application of the hash function on the retrieved first set of container images. In an embodiment, each hash value of the first ordered set of hash values may include a root filesystem hash and an argument hash for each container of the retrieved first set of container images.

In an embodiment, the root filesystem of a container image may correspond to a complete set of files and directories that may define an operating environment that may be associated with a container created from the container image. This may include system libraries, application binaries, configuration files, and additional dependencies that may be recommended for the container associate with the container image to function. The root filesystem hash may correspond to a cryptographic fingerprint of the entire set of files in the root filesystem of the container image. The root filesystem hash may be generated by applying a cryptographic hash function (such as SHA-256 or SHA-384) over the files in the root filesystem of the container image. This ensures that any alterations in the files whether through modification, addition, or deletion would result in a completely different hash value. For example, when a container image includes a set of configuration files for a web server and one file is altered to change a setting, the root filesystem hash would change indicating this modification.

In an embodiment, arguments in the container image may correspond to configuration parameters or settings that may be passed to the container during its build or runtime. These arguments may include environment variables, resource limits, command-line options, or startup commands that may be needed for the execution of the container associated with the container image. For example, a container for a database application may include arguments specifying environment variables such as DB_HOST or DB_PORT, runtime constraints such as memory limits, or specific startup scripts. The argument hash may correspond to a cryptographic fingerprint of these arguments associated with the container image. The argument hash may be generated by applying the cryptographic hash function (such as SHA-256 or SHA-384) over the files. This ensures that any alterations in the arguments, such as altering a memory limit or modifying an environment variable, would produce a completely different hash value.

At 308, a policy generation operation may be executed. In an embodiment, in the policy generation operation, the controller 214 may be configured to generate the policy 218 including the first ordered set of hash values. The first ordered set of hash values may be arranged based on the first initiating sequence, which defines the specific order in which the containers associated with the retrieved first set of container images are to be initialized. The arrangement of the first ordered set of hash values may serve as a robust verification mechanism, ensuring that the sequence of container initialization adheres to the expected order (e.g., the first initiating sequence). This verification mechanism helps maintain the integrity of the sequence of the container initialization by highlighting unauthorized modifications to the first initiating sequence or omission of the container during the container initialization. For example, for a database container that must start before a web server container, the verification mechanism may ensure that this sequence is strictly followed by referring to the first initiating sequence from the policy 218. Details about the verification based on the policy 218 are provided, for example, in FIG. 4.

The policy 218 may further include a set of constraints that may be recommended for regulating the execution of the containers associated with the retrieved first set of container images. In an embodiment, the set of constraints may define specific operational requirements such as expected runtime environment, resource allocation, networking rules, security protocols, or container image verification standards. By way of example, and not by limitation, the set of constraints may specify which hash function (e.g., SHA-256, or SHA-384) to apply on the container images to generate the root filesystem hash and argument hash of each container image. The controller 214 may be further configured to store the policy 218 in a secure and tamper-resistant storage mechanism within the control plane 210. In an embodiment, the policy 218 may be stored in a secure element or a hardware-backed storage to ensure its integrity and confidentiality. Such storage mechanisms may employ cryptographic techniques to prevent unauthorized access or modification of the policy 218. The secure storage of the policy 218 may ensure that the first ordered set of hash values and the set of constraints remain immutable and protected against potential security threats.

FIG. 4 is a diagram that illustrates exemplary operations for regulating the execution of the set of containers, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 416, as described herein. The exemplary operations illustrated in the block diagram 400 may start at 402 and may be performed by any computing system, apparatus, or device, such as by the computer 102 of FIG. 1 or the system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a configuration reception operation may be executed. In an embodiment, in the contract reception operation, the controller 214 may be configured to receive the configuration file associated with the second set of container images from the electronic device 204. In an embodiment, the configuration file may include user-defined preferences (e.g., localization options, user-defined threshold for specific operations, and the like) associated with the second set of container images, system parameters (e.g., memory allocation, CPU usage limits, network configuration, and the like) associated with the second set of container images, or additional configuration (e.g., setting up persistent storage, configuring environment variables and secrets for sensitive data) associated with the second set of container images. Details about the configuration file are provided, for example, in FIG. 2.

In an embodiment, based on the received configuration file, the controller 214 may be further configured to generate the deployment instructions to perform the range of functions on the confidential virtual machine 212. The range of functions may include orchestrating deployment and operations of the containers within the confidential virtual machine 212. The kubelet 220 may be further configured to receive the deployment instructions from the controller 214. The kubelet 220 may be further configured to generate the CRI request to communicate with the container runtime 222. Based on the CRI request, the kubelet 220 may provide the deployment instructions received from the controller 214 to the container management service 224 of the container runtime 222. The kubelet 220 may communicate with the container runtime 222 through the CRI.

At 404, a second retrieval operation may be executed. In an embodiment, in the second retrieval operation, the container management service 224 may be configured to receive the CRI request from the kubelet 220. Based on the CRI request, the container management service 224 may be further configured to identify the second initiating sequence of the second set of containers associated with the second set of container images. The container management service 224 may be further configured to establish a secure communication channel with the one or more data sources 206 (e.g., the image repository) to ensure data integrity and confidentiality during the second retrieval operation. The secure communication channel may utilize encryption protocols such as transport layer security (TLS) to safeguard the transmission of data, thereby ensuring the second set of container images are not intercepted or tampered with during transit.

Prior to initiating the retrieval of the second set of container images, the container management service 224 may be further configured to perform an authentication handshake with the one or more data sources 206. This handshake may include validating credentials such as usernames and passwords, or more robust authentication mechanisms such as cryptographic tokens, digital certificates, and the like. For example, if the one or more data sources 206 may require token-based authentication, the container management service 224 may provide a valid token to gain access to the one or more data sources 206. Once authenticated, the container management service 224 may be further configured to query the one or more data sources 206 (e.g., the image repository) based on the CRI request received from the kubelet 220 to locate the second set of container images. Further, the container management service 224 may be configured to retrieve (or pull) the second set of container images from the one or more data sources 206 based on the CRI request.

At 406, a second hash calculation operation may be executed. In an embodiment, in the second hash calculation operation, the container management service 224 may be configured to apply the hash function on the retrieved second set of container images. Details about the hash function are provided, for example, in FIG. 3. The container management service 224 may be further configured to generate the second ordered set of hash values associated with the retrieved second set of container images. The second ordered set of hash values may be computed based on the application of the hash function on the retrieved second set of container images. In an embodiment, each hash value of the second ordered set of hash values may include a root filesystem hash and an argument hash for each container of the retrieved second set of container images. Details about the root filesystem hash and the argument hash are provided, for example, in FIG. 3.

The container management service 224 may be further configured to compare a first hash value of the first ordered set of hash values with a first hash value of the second ordered set of hash values. The first hash value of the first ordered set of hash values may be associated with a first container image of the retrieved first set of container images. Additionally, the first hash value of the second ordered set of hash values may be associated with a first container image of the retrieved second set of container images. For the sake of brevity, the first hash value of the first ordered set of hash values is hereinafter referred to as a “first hash value” and the first hash value of the second ordered set of hash values is hereinafter referred to as a “second hash value”. Additionally, the first container image of the retrieved first set of container images is hereinafter referred to as a “first container image” and the first hash value of the retrieved second set of container images is hereinafter referred to as a “second container image”.

The first hash value may include a first root filesystem hash value associated with the first container image, and a first argument hash value associated with the first container image. Additionally, the second hash value may include a second root filesystem hash value associated with the second container image, and a second argument hash value associated with the second container image. In an embodiment, the first hash value may be included in the policy 218 and the policy 218 may not be directly accessible to the container management service 224 to maintain confidentiality and integrity. When the first hash value may be needed for comparison with the second hash value, the controller 214 may be further configured to provide the first hash value as an input argument to the kubelet 220. The kubelet 220 may be further configured to provide the first hash value to the container management service 224. In an embodiment, the kubelet 220 may provide the first hash value in the CRI request. Thus, the container management service 224 enhances security by performing dual verification (e.g., the verification of the first root filesystem hash value with the second root filesystem hash value, and the first argument hash value with the second argument hash value), thereby preventing unauthorized modifications to the sequence of the initiation of the containers associated with the retrieved second set of container images.

At 408, it may be determined whether the first hash value and the second hash value match. In an embodiment, the container management service 224 may be configured to compare both the first root filesystem hash value with the second root filesystem hash value, and the first argument hash value with the second argument hash value. In additional embodiment, the container management service 224 may be configured to compare one of the first root filesystem hash value with the second root filesystem hash value, and the first argument hash value with the second argument hash value. In case the first hash value and the second hash value may not match, the container management service 224 may be further configured to determine a first mismatch between the first hash value and the second hash value. Further, the control may be transferred to 410. Alternatively, in case the first hash value and the second hash value match, the container management service 224 may be further configured to determine a first match between the first hash value and the second hash value. Further, the control may be transferred to 414.

At 410, a container restriction operation may be executed. In an embodiment, in the container restriction operation, the container management service 224 may be configured to regulate the execution of a container that may be associated with the second container image based on the determination of the first mismatch. The regulation may correspond to restriction of the execution of the container that may be associated with the second container image to prevent unauthorized or potentially malicious behavior. For example, if the first hash value and the second hash value may not match, the first mismatch may indicate tampering or inconsistency in the second container image. Thus, the container management service 224 ensures only verified and policy-compliant containers are allowed to execute, thereby maintaining integrity, security, and compliance of the system 202.

At 412, a termination operation may be executed. In an embodiment, in the termination operation, the container management service 224 may be configured to terminate the pod deployment operation associated with the pod 226 including the retrieved second set of container images (e.g., the first container 226A, the second container 226B, the third container 226C, and the fourth container 226D). The termination may be triggered based on the regulation (or restriction) of the execution of the container. Specifically, when the first hash value and the second hash value may not match, it may indicate potential foul play, tampering, or unauthorized manipulation of the retrieved second set of container images. In response, the container management service 224 may restrict the execution of the container that may be associated with the second container image. Further, the container management service 224 may be further configured to update a status associated with the pod to fail and mark the pod deployment operation as failed. By terminating the pod deployment operation, the container management service 224 ensures compliance with integrity and security requirements, preventing the execution of potentially compromised or unauthorized containers.

At 414, it may be determined whether the order of the container is correct. In an embodiment, after the comparison of the first hash value and the second hash value match, the container management service 224 may be configured to initialize a counter value indicating a regulation count associated with the second set of containers to track a sequence of successful hash validation. In an embodiment, the regulation count may correspond to a total count of containers (of the second set of containers) that may be successfully initiated. For example, when one container has been successfully initiated, the counter value may correspond to one indicating that the regulation count is one. The container management service 224 may be configured to modify the counter value based on the comparison of the first ordered set of hash values with the second ordered set of hash values. For example, after the successful comparison of the first ordered set of hash values with the second ordered set of hash values corresponding to the successfully initiated container, the container management service 224 may modify the counter value from zero to one.

The container management service 224 may be further configured to determine a positional value associated with the second hash value. In an embodiment, the positional value may correspond to a position of the second hash value in the second ordered set of hash values. For example, when the second hash value may be positioned at a second instance in the second ordered set of hash values, the positional value may correspond to two. Further, the container management service 224 may be configured to compare the positional value with the counter value.

In case the positional value and the counter value may not match, the container management service 224 may be further configured to determine a second mismatch between the positional value and the counter value. Further, the control may be transferred to 410. Alternatively, in case the positional value and the counter value match, the container management service 224 may be further configured to determine a second match between the first hash value and the second hash value. Further, the control may be transferred to 416. For example, based on the determination of the first match between the first hash value and the second hash value match, the container management service 224 may modify (e.g., increment) the counter value by 1 to track the sequence of successful hash validation. Further, the container management service 224 may determine that the positional value associated with the second hash value is 1. Thus, the container management service 224 may determine the second match.

Although it is mentioned that the container management service 224 may determine the positional value associated with the second hash value, in various embodiments, each container image of the retrieved second set of container images may include a sequence value (e.g., a numeric value). The sequence value may indicate the respective position or order of execution of the retrieved second set of container images. Further, the container management service 224 may be configured to compare the sequence value with the counter value.

At 416, a container initialization operation may be executed. In an embodiment, in the container initialization operation, the container management service 224 may be configured to regulate the execution of the container that may be associated with the second container image based on the determination of the second match. The regulation may correspond to an initiation of the execution of the container that may be associated with the second container image.

The operations described in 408 through 416 may be performed iteratively for each container image of the retrieved first set of container images and each container image of the retrieved second set of container images. The container management service 224 may execute these operations in sequence. Once the operations are completed for a given container image, the container management service 224 may proceed to the next container image in the second initiating sequence, repeating the operations. In an embodiment, based on the successful initiation of the containers associated with the retrieved second set of container images, the container management service 224 may be further configured to update the status associated with the pod to success and mark the pod deployment operation as complete. This iterative approach ensures comprehensive validation and integrity enforcement for the initiation of the containers associated with the retrieved second set of container images. Additionally, this indicates that the retrieved second set of container images is identical to the retrieved first set of container images.

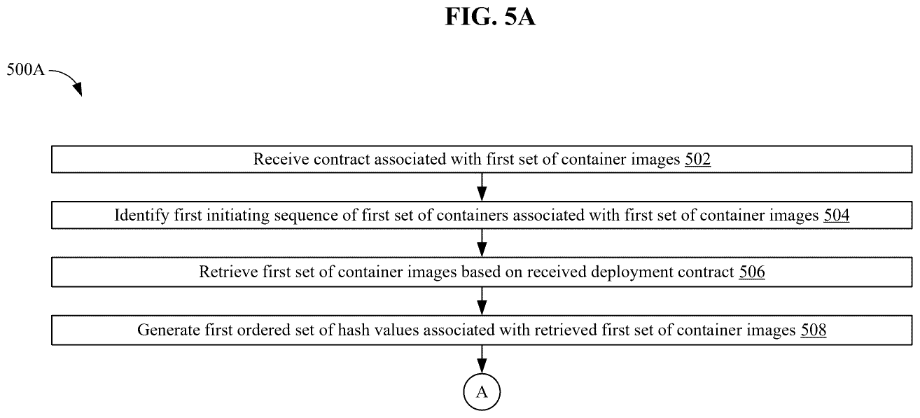

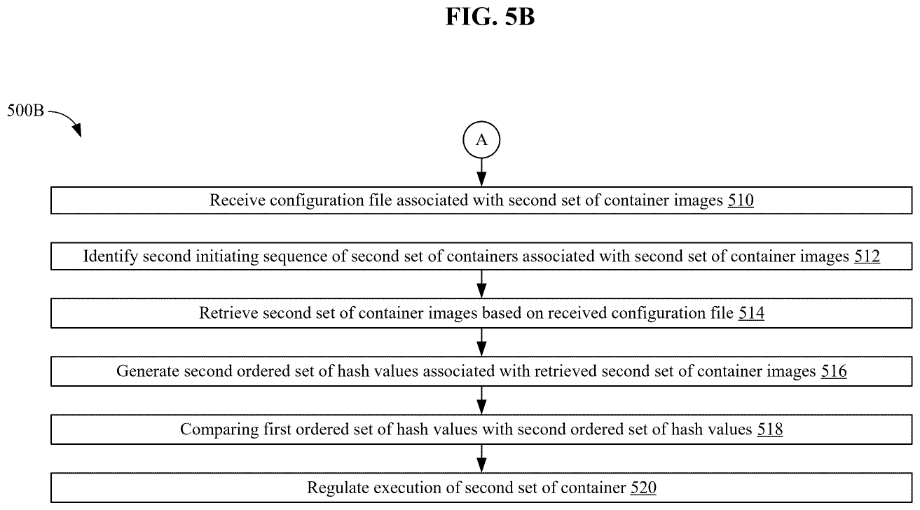

FIGS. 5A and 5B are diagrams that collectively illustrate a flowchart of an exemplary method for regulating the execution of the set of containers, in accordance with an embodiment of the disclosure. FIGS. 5A and 5B are explained in conjunction with elements from FIG. 1, FIG. 2, FIG. 3, and FIG. 4A. With reference to FIGS. 5A and 5B, there is shown a flowchart 500. The operations of the exemplary method may be executed by any computing system, for example, by the computer 102 of FIG. 1 or the system 202 of FIG. 2. The operations of the flowchart 500 may start at 502.

Referring now to FIG. 5A, at 502, the contract 216 associated with the first set of container images is received. In an embodiment of the disclosure, the controller 214 may be configured to receive the contract 216 associated with the first set of container images. In an embodiment, the contract 216 may correspond to the specification that may define the set of rules, the constraints, and the parameters under which a pod that includes containers (associated with the first set of container images) is to be deployed. Further, the contract 216 may include the specification of authorized container images, the first initiating sequence, the security requirements, the integrity check, and additional operational characteristics that must be adhered to during the deployment of the pod. Details about the reception of the contract 216 are provided, for example, in FIG. 2, and FIG. 3.

At 504, the first initiating sequence of the first set of containers associated with the first set of container images is identified. In an embodiment of the disclosure, the controller 214 may be configured to identify the first initiating sequence of the first set of containers associated with the first set of container images. The first initiating sequence may correspond to a desired startup order associated with the first set of containers. Details about the identification of the first initiating sequence are provided, for example, in FIG. 2, and FIG. 3.

At 506, the first set of container images is retrieved based on the received contract 216. In an embodiment of the disclosure, the controller 214 may be configured to establish the secure communication channel with the one or more data sources 206 (e.g., the image repository) to ensure data integrity and confidentiality. The controller 214 may be further configured to retrieve the first set of container images based on the contract 216. Details about the retrieval of the first set of container images are provided, for example, in FIG. 2, and FIG. 3.

At 508, the first ordered set of hash values associated with the retrieved first set of container images is generated. In an embodiment of the disclosure, the controller 214 may be configured to apply the hash function on the retrieved first set of container images. The hash function may correspond to the mathematical algorithm that may convert the input into a fixed-size output that may be referred to as the hash value. The controller 214 may be further configured to generate the first ordered set of hash values associated with the retrieved first set of container images. In an embodiment, the first ordered set of hash values may be generated based on the identified first initiating sequence. Details about the computation of the first ordered set of hash values are provided, for example, in FIG. 2, and FIG. 3.

Referring now to FIG. 5B, at 510, the configuration file associated with the second set of container images is received. In an embodiment of the disclosure, the controller 214 may be configured to receive the configuration file from the electronic device 204. Based on the received configuration file, the controller 214 may be further configured to generate the deployment instructions to perform the range of functions on the confidential virtual machine 212.

The kubelet 220 may be further configured to receive the deployment instructions from the controller 214. Based on the received deployment instructions, the kubelet 220 may be further configured to manage the lifecycle of pods such as scheduling the containers for execution, updating container images, reporting container health status, and handling container failures or restarts. In an embodiment, the kubelet 220 may be further configured to generate the CRI request to communicate with the container management service 224 of the container runtime 222.

At 512, the second initiating sequence of the second set of containers associated with the second set of container images is identified. In an embodiment of the disclosure, the container management service 224 may be configured to identify the second initiating sequence of the second set of containers. The second initiating sequence may correspond to a desired startup order associated with the second set of containers. Details about the identification of the second initiating sequence are provided, for example, in FIG. 2, and FIG. 3.

At 514, the second set of container images is retrieved based on the received configuration file. In an embodiment of the disclosure, the container management service 224 may be configured to establish the secure communication channel with the one or more data sources 206 (e.g., the image repository) to ensure data integrity and confidentiality. The container management service 224 may be further configured to retrieve the second set of container images based on the configuration file. Details about the retrieval of the second set of container images are provided, for example, in FIG. 2, and FIG. 3.

At 516, the second ordered set of hash values associated with the retrieved second set of container images is generated. In an embodiment of the disclosure, the container management service 224 may be configured to apply the hash function on the retrieved second set of container images. The hash function may correspond to the mathematical algorithm that may convert the input into a fixed-size output that may be referred to as the hash value. The container management service 224 may be further configured to generate the second ordered set of hash values associated with the retrieved second set of container images. In an embodiment, the second ordered set of hash values may be generated based on the identified second initiating sequence. Details about the computation of the second ordered set of hash values are provided, for example, in FIG. 2, and FIG. 4.

At 518, the first ordered set of hash values is compared with the second ordered set of hash values. In an embodiment of the disclosure, the container management service 224 may be configured to compare the first ordered set of hash values with the second ordered set of hash values. The comparison of the first ordered set of hash values with the second ordered set of hash values may be sequential such that the container management service 224 may compare the first hash value (of the first ordered set of hash values) with the second hash value (of the second ordered set of hash values). Details about the comparison of the first ordered set of hash values and the second ordered set of hash values are provided, for example, in FIG. 2, and FIG. 3.

At 520, execution of the second set of containers is regulated. In an embodiment of the disclosure, in case the first hash value and the second hash value may not match, the container management service 224 may be further configured to determine the first mismatch between the first hash value and the second hash value. The container management service 224 may be configured to regulate the execution of a container that may be associated with the second container image based on the determination of the first mismatch. The regulation may correspond to restriction of the execution of the container that may be associated with the second container image.

Alternatively, in case the first hash value and the second hash value match, the container management service 224 may be further configured to determine a first match between the first hash value and the second hash value. The container management service 224 may be configured to regulate the execution of the container that may be associated with the second container image based on the determination of the first match. The regulation may correspond to an initiation of the execution of the container that may be associated with the second container image.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable a reader of ordinary skill in the art to understand the embodiments disclosed herein.

What is claimed is:

1. A computer-implemented method, comprising:
receiving, by a computer, a configuration file associated with a first set of container images;
identifying, by the computer, a first initiating sequence of a first set of containers associated with the first set of container images, wherein the first initiating sequence is identified based on the received configuration file;
retrieving, by the computer, the first set of container images based on the received configuration file;
generating, by the computer, a first ordered set of hash values associated with the retrieved first set of container images, wherein the first ordered set of hash values is generated based on the identified first initiating sequence;
comparing, by the computer, the first ordered set of hash values with a second ordered set of hash values, wherein the second ordered set of hash values is associated with a container policy; and
regulating, by the computer, an execution of the first set of containers based on the comparison of the first ordered set of hash values with the second ordered set of hash values.

2. The computer-implemented method of claim 1, further comprising:
receiving, by the computer, a deployment contract associated with a second set of container images;
identifying, by the computer, a second initiating sequence of a second set of containers associated with the second set of container images, wherein the second initiating sequence is identified based on the received deployment contract;
retrieving, by the computer, the second set of container images based on the received deployment contract;
generating, by the computer, the second ordered set of hash values associated with the retrieved second set of container images, wherein the second ordered set of hash values is generated based on the identified second initiating sequence; and
generating, by the computer, the container policy based on the second ordered set of hash values.

3. The computer-implemented method of claim 1, further comprising comparing, by the computer, a hash value of the first ordered set of hash values with a hash value of the second ordered set of hash values.

4. The computer-implemented method of claim 3, wherein:
the hash value of the first ordered set of hash values is associated with a container image of the retrieved first set of container images,
the method further comprising regulating, by the computer, the execution of a container of the first set of containers based on the comparison of the hash value of the first ordered set of hash values with the hash value of the second ordered set of hash values, and
the container is associated with the container image.

5. The computer-implemented method of claim 4, wherein the hash value of the first ordered set of hash values comprises a first root filesystem hash value associated with the container image and a first argument hash value associated with the container image.

6. The computer-implemented method of claim 4, further comprising:
determining, by the computer, a mismatch between the hash value of the first ordered set of hash values and the hash value of the second ordered set of hash values based on the comparison of the hash value of the first ordered set of hash values with the hash value of the second ordered set of hash values; and
regulating, by the computer, the execution of the container based on the determination of the mismatch, wherein the regulation of the execution of the container corresponds to restriction of the execution of the container.

7. The computer-implemented method of claim 6, further comprising terminating, by the computer, a pod deployment operation associated with the retrieved first set of container images based on the determination of the mismatch and the regulation of the execution of the container.

8. The computer-implemented method of claim 4, further comprising:
determining, by the computer, a match between the hash value of the first ordered set of hash values and the hash value of the second ordered set of hash values based on the comparison of the hash value of the first ordered set of hash values with the hash value of the second ordered set of hash values; and
regulating, by the computer, the execution of the container based on the determination of the match, wherein the regulation of the execution of the container corresponds to initiation of the execution of the container.

9. The computer-implemented method of claim 1, further comprising:
modifying, by the computer, a counter value indicating a regulation count associated with the first set of containers based on the comparison of the first ordered set of hash values with the second ordered set of hash values;
comparing, by the computer, a positional value associated with a hash value of the first ordered set of hash values with the counter value; and
regulating, by the computer, the execution of a container of the first set of containers based on the comparison of the positional value with the counter value, wherein the container is associated with a container image of the retrieved first set of container images.

10. The computer-implemented method of claim 9, further comprising:
determining, by the computer, a mismatch between the positional value and the counter value based on the comparison of the positional value with the counter value; and
regulating, by the computer, the execution of the container based on the determination of the mismatch, wherein the regulation of the execution of the container corresponds to restriction of the execution of the container.

11. The computer-implemented method of claim 9, further comprising:
determining, by the computer, a match between the positional value and the counter value based on the comparison of the positional value with the counter value; and
regulating, by the computer, the execution of the container based on the determination of the match, wherein the regulation of the execution of the container corresponds to initiation of the execution of the container.

12. The computer-implemented method of claim 1, further comprising:
applying, by the computer, a hash function on the retrieved first set of container images; and
generating, by the computer, the first ordered set of hash values associated with the retrieved first set of container images, wherein the first ordered set of hash values is generated based on the identified first initiating sequence and the application of the hash function on the retrieved first set of container images.

13. A computer system, comprising:
a processor set;
one or more computer-readable storage media; and
program instructions stored on the one or more computer-readable storage media, the program instructions executable by the processor set to cause the processor set to:
receive a deployment contract associated with a first set of container images;
identify a first initiating sequence of a first set of containers associated with the first set of container images;
retrieve the first set of container images based on the received deployment contract;
generate a first ordered set of hash values associated with the retrieved first set of container images, wherein the first ordered set of hash values is generated based on the identified first initiating sequence;
receive a configuration file associated with a second set of container images;
identify a second initiating sequence of a second set of containers associated with the second set of container images, wherein the second initiating sequence is identified based on the received configuration file;
retrieve the second set of container images based on the received configuration file;
generate a second ordered set of hash values associated with the retrieved second set of container images, wherein the second ordered set of hash values is generated based on the identified second initiating sequence;
compare the first ordered set of hash values with the second ordered set of hash values; and
regulate an execution of the second set of containers based on the comparison of the first ordered set of hash values with the second ordered set of hash values.

14. The computer system of claim 13, wherein the program instructions further cause the processor set to compare a hash value of the first ordered set of hash values with a hash value of the second ordered set of hash values.

15. The computer system of claim 14, wherein:
the hash value of the first ordered set of hash values is associated with a container image of the retrieved first set of container images,
the hash value of the second ordered set of hash values is associated with a container image of the retrieved second set of container images,
the program instructions further cause the processor set to regulate the execution of a container of the second set of containers based on the comparison of the hash value of the first ordered set of hash values with the hash value of the second ordered set of hash values, and
the container is associated with the container image of the retrieved second set of container images.

16. The computer system of claim 15, wherein:
the hash value of the first ordered set of hash values comprises, a first root filesystem hash value associated with the container image of the retrieved first set of container images, and a first argument hash value associated with the container image of the retrieved first set of container images, and
the hash value of the second ordered set of hash values comprises, a second root filesystem hash value associated with the container image of the retrieved second set of container images, and a second argument hash value associated with the container image of the retrieved second set of container images.

17. The computer system of claim 15, wherein the program instructions further cause the processor set to:
determine a mismatch between the hash value of the first ordered set of hash values and the hash value of the second ordered set of hash values based on the comparison of the hash value of the first ordered set of hash values with the hash value of the second ordered set of hash values; and
regulate the execution of the container based on the determination of the mismatch, wherein the regulation of the execution of the container corresponds to a restriction on the execution of the container.

18. The computer system of claim 17, wherein the program instructions further cause the processor set to terminate a pod deployment operation associated with the retrieved second set of container images based on the determination of the mismatch and the regulation of the execution of the container.

19. The computer system of claim 15, wherein the program instructions further cause the processor set to:
determine a match between the hash value of the first ordered set of hash values and the hash value of the second ordered set of hash values based on the comparison of the hash value of the first ordered set of hash values with the hash value of the first ordered set of hash values; and
regulate the execution of the container based on the determination of the match, wherein the regulation of the execution of the container corresponds to an initiation of the execution of the container.

20. A computer-program product for container regulation, the computer-program product comprising:
one or more computer-readable storage media; and
program instructions stored on the one or more computer-readable storage media to perform operations comprising:
receiving a configuration file associated with a first set of container images;
identifying a first initiating sequence of a first set of containers associated with the first set of container images, wherein the first initiating sequence is identified based on the received configuration file;
retrieving the first set of container images based on the received configuration file;
generating a first ordered set of hash values associated with the retrieved first set of container images, wherein the first ordered set of hash values is generated based on the identified first initiating sequence;
comparing the first ordered set of hash values with a second ordered set of hash values, wherein the second ordered set of hash values is associated with a container policy; and
regulating an execution of the first set of containers based on the comparison of the first ordered set of hash values with the second ordered set of hash values.
